(19) United States
(12) Patent Application Publication
(10) Pub. No.: US 2013/0138804 A1
(43) Pub. Date: May 30, 2013

(54) SERVER RACK SYSTEM

(71) Applicant: Liu-Shen Hsien, Taipei City (TW)

(72) Inventor: Liu-Shen Hsien, Taipei City (TW)

(73) Assignee: INVENTEC CORPORATION, Taipei City (TW)

(21) Appl. No.: 13/399,671

(22) Filed: Feb. 17, 2012

(30) Foreign Application Priority Data
Nov. 28, 2011 (CN) 201110383917.0

(51) Int. Cl. G06F 15/173

(52) U.S. Cl. 709/224

(57) ABSTRACT

A server rack system includes a rack, a rack management module, a plurality of servers, a management network connection module, and an identification module. The rack management module is located in the rack and is coupled to a management network line. Each server is respectively plugged in the rack, and respectively has a baseboard management controller (BMC) used to monitor a working state of the server. The management network connection module is located in the rack and used to connect the rack management module and the BMCs through the management network line. The identification module is located in the rack, so as to enable the corresponding server to generate an identification code signal. The rack management module identifies a physical position of each server in the rack according to the identification code signal of each server and a corresponding relation record between the identification code signal and the physical position.

### CROSS-REFERENCE TO RELATED APPLICATION

This application claims the priority benefit of China application serial no. 201110383917.0, filed on Nov. 28, 2011. The entirety of the above-mentioned patent application is hereby incorporated by reference herein and made a part of this specification.

### BACKGROUND OF THE INVENTION

1. Field of the Invention

The present invention generally relates to a server system, in particular, to a server rack system.

2. Description of Related Art

Recently, a computer server is developed from a conventional single server to a rack server in which a plurality of servers is placed in a rack. The amount of servers in the rack server is large, so that management and control for each server become a critical technique of the rack server. However, the existing rack server is in lack of an effective management and control solution for each server, thereby seriously obstructing development of the rack server. For example, the conventional rack server cannot detect a practical position (that is, a physical position) of each server in the rack, so that the management and the control of the server are inconvenient, for example, when a certain server in the rack is abnormal or have excessively high temperature, usually it takes quite a long time to know the practical position of the server having the problem, thereby corresponding processing the server having the problem.

Therefore, it is an important problem how to enable the rack server to detect the practical position of each server, so as to know state and information of the server on a certain specific physical position.

### SUMMARY OF THE INVENTION

Accordingly, the present invention is directed to a server rack system, in which when an identification module and a corresponding server generate a corresponding relation, an identification code signal is generated and transmitted to a rack management module through a management network line, so that the rack management module obtains a physical position of the server according to the identification code signal.

The present invention provides a server rack system, which includes a rack, a rack management module, a plurality of servers, a management network connection module, and at least one identification module. The rack management module is located in the rack and is coupled to a management network line. The servers is respectively plugged in the rack, and respectively has a baseboard management controller (BMC) used to monitor a working state of the server. The management network connection module is located in the rack and is coupled to the management network line, and is used to connect the rack management module and the BMCs through the management network line. The identification module is located in the rack and is corresponding to each server. When any one of the servers is inserted in the rack and generates a corresponding relation with any one of the identification modules, the server generates an identification code signal. The BMC of the server obtains the identification code signal, and sends the identification code signal to the rack management module through the management network line. The rack management module pre-stores a corresponding relation record between physical positions in the rack and identification codes, and after receiving the identification code signal, the rack management module identifies the physical position of the server in the rack according to the corresponding relation record.

In an embodiment of the present invention, the corresponding relation between the server and the identification module is a mechanism connection relation, the identification module has a plurality of elastic plates, one side of each server has a plurality of pins, and when the elastic plates contact the pins, the server generates the identification code signal.

In an embodiment of the present invention, the corresponding relation between the server and the identification module is an electrical connection relation, the identification module is a rack backplane, located on a back side of the rack, and when any one of the servers is inserted in the rack and is electrically connected to the rack backplane, the server generates the identification code signal.

In an embodiment of the present invention, the server rack system further includes an application network connection module, located in the rack and coupled to an application network line, and respectively coupled to network interfaces of the servers through the application network line, in which the servers provide application services through the application network line.

In an embodiment of the present invention, the management network line and/or the application network line is an Ethernet network line.

In an embodiment of the present invention, the server rack system further includes a plurality of fan modules, respectively corresponding to the servers, in which the rack management module obtains a corresponding relation between each server and each fan module according to the physical position of each server in the rack, obtains working state information of each server from each BMC through the management network line, and controls operation of each fan module according to the corresponding relation between each server and each fan module and the working state information of each server.

In an embodiment of the present invention, the server rack system further includes an power module, electrically connected to the rack management module, the management network connection module, and the plurality of servers, and used to provide a working voltage required by the rack management module, the management network connection module, and the servers.

In an embodiment of the present invention, the rack management module obtains entire power consumption information of the server rack system through the power module, and obtains power consumption information of each server from each BMC through the management network line. The rack management module manages operation of each server located on each physical position in the rack through each BMC according to the entire power consumption information and the power consumption information of each server.

In an embodiment of the present invention, the rack management module manages power supply of the power module for the servers according to the physical position of each server in the rack.

In an embodiment of the present invention, when detecting an identification code signal on a corresponding physical position, the rack management module controls the power module to open the power supply on the corresponding physical position. When losing the identification code signal, the rack management module controls the power module to cut off the power supply on the corresponding physical position.

In an embodiment of the present invention, the rack management module provides a user interface through the management network line, the user interface provides a display interface, for enabling an administrator to find the physical position of each server in the server rack system through the display interface, and/or read power consumption of each server on the physical position in the rack.

In an embodiment of the present invention, the identification code signal has at least one flag bit, used to represent the physical position of the server rack system in a machine room.

In an embodiment of the present invention, the rack management module is an intelligent platform management interface (IPMI).

Based on the above mentioned, in a server rack system according to an embodiment of the present invention, an identification module may enable a corresponding server to generate a corresponding identification code signal, and send the identification code signal to a rack management module through a management network line, and the rack management module identifies a physical position of the server in a rack according to a corresponding relation record between the physical position and the identification code signal. Therefore, a practical position of each server in the rack may be known, so that operation of relevant elements is controlled corresponding to a working state signal of each server.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a server rack system according to an embodiment of the present invention.

FIG. 2 is a schematic view of a corresponding relation between a server and an identification module according to an embodiment of the present invention.

FIG. 3 is a schematic view of a corresponding between a server and an identification module according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

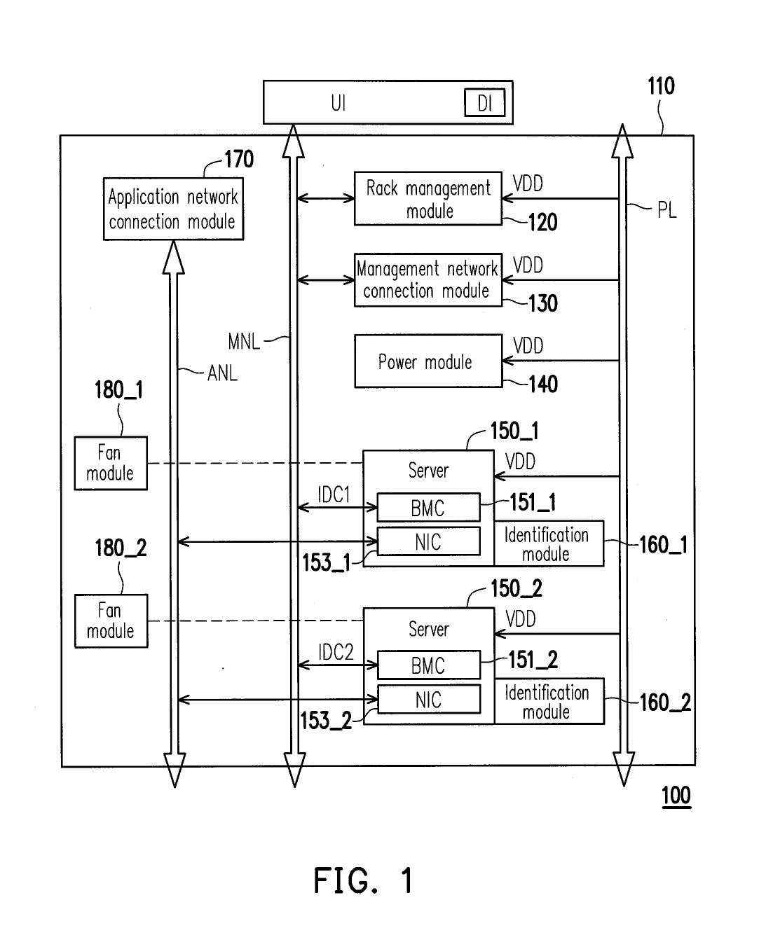

FIG. 1 is a schematic view of a server rack system according to an embodiment of the present invention. Referring to FIG. 1, in this embodiment, the server rack system 100 includes a rack 110, rack management module 120, a management network connection module 130, an power module 140, a plurality of servers (for example, 150_1, 150_2), a plurality of identification modules (for example, 160_1, 160_2), an application network connection module 170, and a plurality of fan modules (for example, 180_1, 180_2), in which the rack management module 120 is, for example, an IPMI.

In this embodiment, the rack management module 120 is located in the rack 110 and coupled to a management network line MNL. The servers (for example, 150_1, 150_2) are located in the rack 110, and each server (for example, 150_1, 150_2) is plugged in the rack 110. Each server (for example, 150_1, 150_2) respectively has a BMC (for example, 151_1, 151_2) and a network interface controller (NIC) (for example, 153_1, 153_2). Each BMC (for example, 151_1, 151_2) is used to monitor a working state of the server (for example, 150_1, 150_2), that is, the BMC 151_1 is used to monitor the working state of the server 150_1, and the BMC 151_2 is used to monitor the working state of the server 150_2, and the remaining is deduced in the same way.

The management network connection module 130 is located in the rack 110 and coupled to the management network line MNL, and is used to monitor messages on the management network line MNL. Further, the management network connection module 130 connects the rack management module 120 and the BMC (for example, 151_1, 151_2) of each server (for example, 150_1, 150_2) through the management network line MNL, that is, may transmit messages of the rack management module 120 to the BMC (for example, 151_1, 151_2), and may transmit messages of the BMC (for example, 151_1, 151_2) to the rack management module 120.

The identification modules (for example, 160_1, 160_2) are located in the rack 110 and corresponding to each server (for example, 150_1, 150_2), for example, the identification module 160_1 is corresponding to the server 150_1, and the identification module 160_2 is corresponding to the server 150_2. The amount of the identification modules is corresponding to the amount of the servers inserted in the rack 110, that is, when the amount of the servers inserted in the rack 110 is 1, the amount of the identification modules is 1, when the amount of the servers inserted in the rack 110 is 2, the amount of the identification modules is 2, and the remaining is deduced in the same way. Alternatively, the amount of the identification modules may be changed according to a corresponding relation between the identification module and the server, that is, when an identification module may be corresponding to all the servers, the amount of the identification modules is 1, when two identification modules may be corresponding to all the servers, the amount of the identification modules is 2, and the remaining is deduced in the same way.

In this embodiment, the corresponding relation between the identification module (for example, 160_1, 160_2) and the server (for example, 150_1, 150_2) is set as 1:1, but the embodiment of the present invention is not limited thereto. When each server (for example, 150_1, 150_2) is inserted in the rack 110 and generates a corresponding relation with the corresponding identification module (for example, 160_1, 160_2), the server (for example, 150_1, 150_2) generates an identification code signal (for example, IDC1, IDC2). The identification code signal (for example, IDC1, IDC2) may be formed by a plurality of bits, and each identification code signal (for example, IDC1, IDC2) may have at least one flag bit used to represent a physical position of the server rack system 100 in a machine room. Further, the corresponding relation between each server (for example, 150_1, 150_2) and the corresponding identification module (for example, 160_1, 160_2) may be a mechanism connection relation or an electrical connection relation, but the present invention is not limited thereto.

Next, when the BMC (for example, 151_1, 151_2) of each server (for example, 150_1, 150_2) obtains the identification code signal (for example, IDC1, IDC2), the BMC sends the identification code signal (for example, IDC1, IDC2) to the rack management module 120 through the management network line MNL. The rack management module 120 pre-stores a corresponding relation record between a plurality of physical positions in the rack 110 and the identification code signals (for example, IDC1, IDC2). Therefore, after receiving the identification code signal (for example, IDC1, IDC2), the rack management module 120 may identify the physical position of the server (for example, 150_1, 150_2) in the rack 110 according to the corresponding relation record. For example, the rack management module 120 may identify the physical position of the server 150_1 in the rack 110 according to the identification code signal IDC1, and identify the physical position of the server 150_2 in the rack 110 according to the identification code signal IDC2.

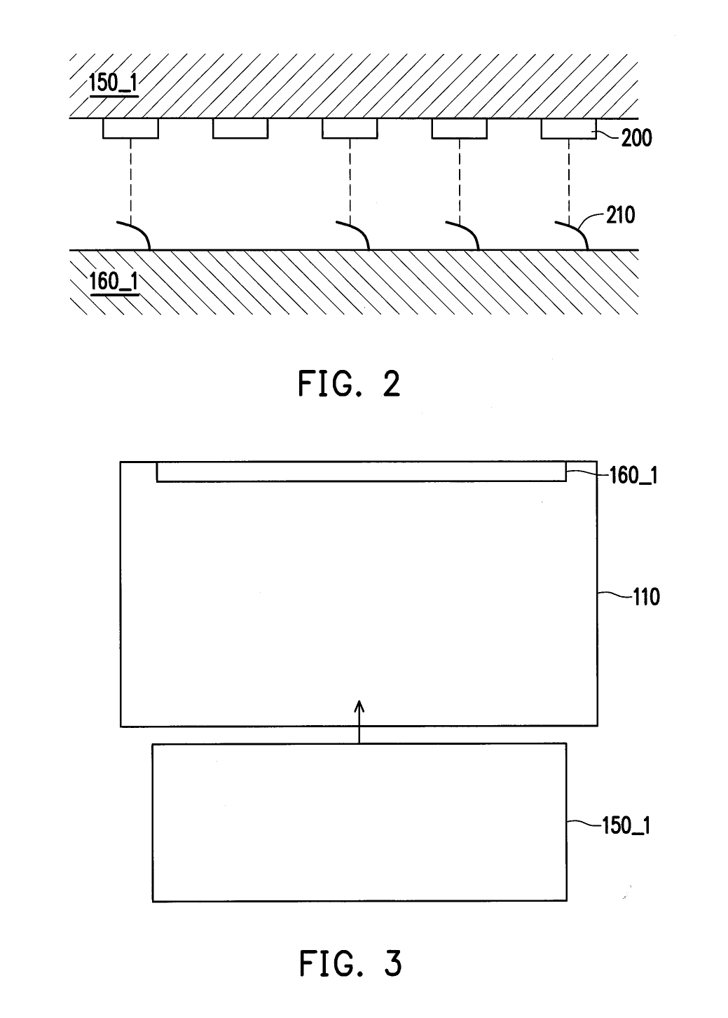

FIG. 2 is a schematic view of a corresponding relation between a server and an identification module according to an embodiment of the present invention. Referring to FIG. 1 and FIG. 2, in this embodiment, it is assumed that the corresponding relation between the server and the corresponding identification module is the mechanism connection relation, and the server 150_1 and the identification module 160_1 are set as an example. Here, one side of the server 150_1 has a plurality of pins 200, and one side of the identification module 160_1 facing the server 150_1 has a plurality of elastic plates 210, in which the elastic plates 210 are used to contact the corresponding pins 200 on the server 150, and shapes of the elastic plates 210 and the pins 200 are used for illustration, but the embodiment of the present invention is not limited thereto. When the pins 200 of the server 150_1 contact the elastic plates 210 of the identification module 160_1, the server 150_1 may generate the identification code signal IDC1 according to a contacting relation between the pins 200 and the elastic plates 210. Further, according to the above illustration, the remaining server (for example, 150_2) and the corresponding identification module (for example, 160_2) may generate the identification code signal IDC2.

In this embodiment, the amount of the elastic plates 210 may be smaller than or equal to the amount of the pins 200, when the amounts of the elastic plates 210 are different and the corresponding relations between the elastic piece 210 and the pin 200 are different, the identification code signals (for example, IDC1, IDC2) generated by the servers (for example, 150_1, 150_2) may be different. For example, when the server having 5 pins 200 contacts the identification module having 4 elastic plates 210, according to different arrangement manners of the elastic plates 210, 5 contacting manners may exist, so as to generate 5 different identification code signals. When the server having 5 pins 200 contacts the identification module having 3 elastic plates 210, according to different arrangement manners of the elastic plates 210, 20 contacting manners may exist, so as to generate 20 different identification code signals. In this embodiment, both the pins 200 and the elastic plates 210 are shown as a row, but in other embodiments, the pins 200 and the elastic plates 210 may be arranged in an array or arranged to be a specific shape, but the embodiment of the present invention is not limited thereto.

In addition to being the mechanism connection relation, the corresponding relation between each server (for example, 150_1, 150_2) and the corresponding identification module (for example, 160_1, 160_2) may be the electrical connection relation. FIG. 3 is a schematic view of a corresponding between a server and an identification module according to another embodiment of the present invention. Referring to FIG. 1 and FIG. 3, in this embodiment, it is assumed that the corresponding relation between the server and the corresponding identification module is the electrical connection relation, and the server 150_1 and the identification module 160_1 are set as an example as well. Here, it is assumed that a direction along which the server 150_1 is inserted in the rack 110 is D1, and the identification module 160_1 is a rack backplane here. In this embodiment, the identification module 160_1 is located on a back side of the rack 110, that is, located on the other side of the rack 110 opposite to the insertion side of the server 150_1. When the server 150_1 is inserted in the rack 110 and is electrically connected to the identification module 160_1, the server 150_1 is triggered by the identification module 160_1 to generate the identification code signal IDC1. Further, the remaining server (for example, 150_2) and the corresponding identification module (for example, 160_2) may generate the identification code signal IDC2 according to the above illustration. In this embodiment, the identification module 160_1 is the rack backplane corresponding to the server 150_1, that is, the identification module 160_1 is electrically connected to the server 150_1, but in other embodiments, the identification module 160_1 may be the rack backplane corresponding to a plurality of servers, that is, the identification module 160_1 may be electrically connected to the plurality of servers, which may be designed by those of ordinary skill in the art.

Referring to FIG. 1, in this embodiment, the application network connection module 170 is located in the rack 110 and is coupled to an application network line ANL, and is respectively coupled to the NICs (for example, 153_1, 153_2) of the servers (for example, 150_1, 150_2) through the application network line ANL, that is, coupled to network interfaces of the servers (for example, 150_1, 150_2), in which the servers (for example, 150_1, 150_2) provide application services through the application network line ANL. In the embodiment of the present invention, the management network line MNL and/or the application network line ANL may be an Ethernet network line, but the present invention is not limited thereto.

Each fan module (for example, 180_1, 180_2) is respectively corresponding to the servers (for example, 150_1, 150_2) according to configuration of the physical positions, for example, the physical position of the fan module 180_1 is corresponding to the physical position of the server 150_1, and the physical position of the fan module 180_2 is corresponding to the physical position of the server 150_2. According to the above-mentioned, the fan module 180_1 is used to lower working temperature of the server 150_1, and the fan module 180_2 is used to lower working temperature of the server 150_2. In this embodiment, each fan module (for example, 180_1, 180_2) is corresponding to one of the servers (for example, 150_1, 150_2), but in other embodiments, according to the design of fan modules or a heat dissipation system, each fan module may be corresponding to two or more servers, which may be changed by those of ordinary skill in the art.

According to the above mentioned, the rack management module 120 obtains the corresponding relation between each server (for example, 150_1, 150_2) and each fan module (for example, 180_1, 180_2) according to the physical position of each server (for example, 150_1, 150_2) in the rack 110. Further, the rack management module 120 may obtain working state information of each server (for example, 150_1, 150_2) from each BMC (for example, 151_1, 151_2) through the management network line MNL, the rack management module 120 respectively controls operation of the fan module (for example, 180_1, 180_2) corresponding to each server (for example, 150_1, 150_2) according to the corresponding relation between each server (for example, 150_1, 150_2) and each fan module (for example, 180_1, 180_2) and the working state information of each server (for example, 150_1, 150_2). For example, when the working state information of the server 150_1 represents that a working amount of the server 150_1 becomes larger, a wind speed of the fan module 180_1 is correspondingly increased; when the working state information of the server 150_1 represents that the working amount of the server 150_1 becomes smaller, the wind speed of the fan module 180_1 is correspondingly decreased; when the working state information of the server 150_1 represents that the server 150_1 enters a sleep state, the fan module 180_1 is correspondingly adjusted to maintain low speed operation.

The power module 140 is electrically connected to the rack management module 120, the management network connection module 130, and each server (for example, 150_1, 150_2) through a power line PL, and is used to provide a working voltage VDD required by the rack management module 120, the management network connection module 130, and the servers (for example, 150_1, 150_2). In this embodiment, the power module 140 is controlled by the rack management module 120, and the rack management module 120 obtains entire power consumption information of the server rack system 100 through the power module 140, and obtains power consumption information of each server (for example, 150_1, 150_2) from each BMC (for example, 151_1, 151_2) through the management network line MNL. The rack management module 120 may be connected to the power module 130 through the management network line MNL or the power line PL.

The rack management module 120 manages each server (for example, 150_1, 150_2) through each BMC (for example, 151_1, 151_2) according to the entire power consumption information and the power consumption information of each server (for example, 150_1, 150_2). For example, when the entire power consumption information exceeds an power consumption upper limit of the rack, a working speed of each server (for example, 150_1, 150_2) is lowered, so as to lower the power consumption information of each server (for example, 150_1, 150_2); when the power consumption information of each server (for example, 150_1, 150_2) exceeds an power consumption upper limit of the server, the working speed of each server (for example, 150_1, 150_2) is correspondingly lowered. The power consumption upper limit of the rack and the power consumption upper limit of the server may be set by those of ordinary skill in the art, but the embodiment of the present invention is not limited thereto.

In addition, the rack management module 120 may manage power supply of the power module 140 for each server (for example, 150_1, 150_2) according to the physical position of each server (for example, 150_1, 150_2) on the rack. The server rack system 100 may periodically inquire the working state of each server (for example, 150_1, 150_2), so that each server (for example, 150_1, 150_2) periodically transmits the identification code signal (for example, IDC1, IDC2) to the rack management module 120, or each server (for example, 150_1, 150_2) periodically transmits the working state information including the identification code signal (for example, IDC1, IDC2) to the rack management module 120. When the rack management module 120 detects the identification code signal IDC1 generated by the server 150_1, the rack management module 120 knows that the physical position of the corresponding server 150_1 is inserted with the server 150_1, here the rack management module 120 controls the power module 140 to open the power supply on the physical position corresponding to the server 150_1. On the contrary, when the rack management module 120 loses the identification code signal IDC1 generated by the server 150_1, that is, the rack management module 120 does not receive the identification code signal IDC1 periodically transmitted by the server 150_1 or the rack management module 120 inquires the working state from the server 150_1 and the identification code signal IDC1 is not returned, the rack management module 120 controls the power module 140 to cut off the power supply on the physical position corresponding to the server 150_1. Therefore, in this embodiment, the rack management module 120 may realize power supply management on the server (for example, 150_1-150_2) in the above manner.

In addition, in this embodiment, the rack management module 120 provides a user interface UI for a system administrator through the management network line MNL, and the user interface UI may have a display interface DI, used to display the physical position of each server (for example, 150_1, 150_2) in the server rack system 100 or other information relevant to the state of the server on a display device (not shown). The system administrator may find the physical position of each server (for example, 150_1, 150_2) in the server rack system through the user interface UI and the display interface DI, and read the power consumption of the server on each physical position in the rack. Further, the system administer may manage the rack management module 120, the management network connection module 130, the power module 140, the servers (for example, 150_1, 150_2), and the fan modules (for example, 180_1, 180_2) in the server rack system 100 through the user interface UI and the display interface DI.

To sum up, in a server rack system according to an embodiment of the present invention, when a server and an identification module generate a corresponding relation, the server may generate an identification code signal corresponding to a physical position, a rack management module identifies the physical position of the server according to the identification code signal, knows a corresponding relation between a fan module and the server, and correctly adjusts operation of the fan module according to a working state of the server. Further, the rack management module monitors and manages the working state of each server according to entire power consumption information provided by an power module, power consumption information of each server, and the physical position of each server on a rack.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A server rack system, comprising:
a rack;
a rack management module, located in the rack and coupled to a management network line;
a plurality of servers, respectively plugged in the rack, and respectively comprising a baseboard management controller (BMC) used to monitor a working state of the server;
a management network connection module, located in the rack and coupled to the management network line, and used to connect the rack management module and the BMCs through the management network line; and
at least one identification module, located in the rack and corresponding to each server;
wherein when any one of the servers is inserted in the rack and generates a corresponding relation with any one of the identification modules, the server generates an identification code signal; the BMC of the server obtains the identification code signal, and sends the identification code signal to the rack management module through the management network line; the rack management module pre-stores a corresponding relation record between a plurality of physical positions in the rack and a plurality of identification codes, and after receiving the identification code signal, the rack management module identifies the physical position of the server in the rack according to the corresponding relation record.

2. The server rack system according to claim 1, wherein the corresponding relation is a mechanism connection relation, the identification module comprises a plurality of elastic plates, one side of each server comprises a plurality of pins, and when the elastic plates contact the pins, each server respectively generates the identification code signal.

3. The server rack system according to claim 1, wherein the corresponding relation is an electrical connection relation, the identification module is a rack backplane, located on a back side of the rack, and when any one of the servers is inserted in the rack and is electrically connected to the rack backplane, the server generates the identification code signal.

4. The server rack system according to claim 1, further comprising:
an application network connection module, located in the rack and coupled to an application network line, and respectively coupled to network interfaces of the servers through the application network line, wherein the servers provide application services through the application network line.

5. The server rack system according to claim 4, wherein the management network line and/or the application network line is an Ethernet network line.

6. The server rack system according to claim 1, further comprising:
a plurality of fan modules, respectively corresponding to the servers;
wherein the rack management module obtains a corresponding relation between each server and each fan module according to the physical position of each server in the rack, obtains working state information of each server from each BMC through the management network line, and controls operation of each fan module according to the corresponding relation between each server and each fan module and the working state information of each server.

7. The server rack system according to claim 1, further comprising:
an power module, electrically connected to the rack management module, the management network connection module, and the servers, and used to provide a working voltage required by the rack management module, the management network connection module, and the servers.

8. The server rack system according to claim 7, wherein the rack management module obtains entire power consumption information of the server rack system through the power module, and obtains power consumption information of each server from each BMC through the management network line; the rack management module manages operation of each server located on each physical position in the rack through each BMC according to the entire power consumption information and the power consumption information of each server.

9. The server rack system according to claim 7, wherein the rack management module manages power supply of the power module for the servers according to the physical position of each server in the rack.

10. The server rack system according to claim 9, wherein when detecting an identification code signal on a corresponding physical position, the rack management module controls the power module to open the power supply on the corresponding physical position; when losing the identification code signal, the rack management module controls the power module to cut off the power supply on the corresponding physical position.

11. The server rack system according to claim 1, wherein the rack management module provides a user interface through the management network line, the user interface provides a display interface, for enabling an administrator to find the physical position of each server in the server rack system through the display interface, and/or read power consumption of each server on the physical position in the rack.

12. The server rack system according to claim 1, wherein the identification code signal comprises at least one flag bit, used to represent the physical position of the server rack system in a machine room.

13. The server rack system according to claim 1, wherein the rack management module is an intelligent platform management interface (IPMI).
